(19) United States
(12) Patent Application Publication
(10) Pub. No.: US 2001/0047418 A1
(43) Pub. Date: Nov. 29, 2001

(54) Shareable high speed internet access via telephone wiring

(76) Inventor: William O. White, Boulder, CO (US)

Correspondence Address: Greenlee, Winner and Sullivan, P.C., Suite 201, 5370 Manhattan Circle, Boulder, CO, 80303, US

(21) Appl. No.: 09/779,294

(22) Filed: Feb. 7, 2001

Related U.S. Application Data
(60) Provisional application No. 60/180,815, filed on Feb. 7, 2000.

(51) Int. Cl. G06F 15/16

(52) U.S. Cl. 709/227

(57) ABSTRACT

The invention is an Internet access system and a method for providing economical high-speed Internet access from shareable locations using an existing telephone infrastructure. The invention comprises a system of multiple shareable terminals connected by telephone wiring to a central server which is in turn connected to the Internet. The shareable terminal is a relatively “dumb” terminal comprising a display, input/output buffers, a DSL modem, telephone line interface circuitry, a keyboard and a mouse. The telephone wiring is common voice-grade telephone wiring normally existing within a building. The central server comprises a computer along with telephone interface circuitry such as a DSLAM and an interface to the Internet. The central server provides the data processing and storage capability for supporting the shareable terminals.

### FIELD OF INVENTION

This invention relates generally to local area networks and particularly to apparatus and methods for using standard telephone lines to provide high speed access to the Internet from shareable locations.

### BACKGROUND OF THE INVENTION

There have been many advancements over the last twenty years in the technology fields of Local Area Networks (LAN's), spectrum utilization techniques involving CSMA/CD (carrier sense, multiple access with collision detection) and DSL (digital subscriber line) and terminals and terminal servers.

There are a variety of technologies used in local area networks, whether over baseband (e.g. telephone wire), broadband (e.g. cable) or wireless links. The primary protocol is TCP/IP (transmission control protocol/internetworking protocol), which is the common protocol used in the Internet. The LAN technology today has transport speeds ranging from 2 megabits/second in a wireless topology to a gigabit/second capability on dedicated fiber lines. The technology in the broadband area has advanced over the last 15 years. Recently DSL products have been brought to market which allow both voice and data to share a two-wire or four-wire telephone circuit typically used to support voice telephone communications.

A basic technology that has been in the marketplace for decades is that of terminals and terminal servers. Terminal technology has evolved over the years, with the basic type, such as the IBM 3270 terminal, being character based. In the mid 1980's a graphical user interface (GUI) was added in the form of an X-Terminal and X-Server based on the UNIX operating system. This provided the first GUI based terminal. The drawback of this protocol was that it required very high bandwidth and as such was better served on a LAN than any lower speed communications technology. The terminal technology has declined in favor of dedicated desktop machines such as personal computers (PCs) which have bundled the terminal functions with the operating system, either in a character form or a GUI form. In the last four years the advancements in terminals have moved into what has been called network terminals, which are variants on the X-Protocol terminals. In this form the network terminal was a simplified personal computer which had no disk drives, fixed or floppy, but still had memory and a low-profile operating system. Therefore it would be considered similar to the X-Terminal technology, but with improvements in the network utilization. Recently, the terminal technology has advanced to a simpler model, which is similar to the IBM 3270 terminal, except that it is GUI based instead of character based. In this type of terminal, data for presentation is transferred from the video and sound buffers in the terminal server to the terminal via a network. The terminal does not have any disk drives or operating systems and has only video display memory.

In recent years, there has been a significant expansion in the use of portable PC's in hotels and motels, particularly by business travelers. An increasing activity is to utilize the modem capability of the portable PC and the in-room telephone service to connect to an Internet Service Provider (ISP). Two problems are often encountered. First, the bandwidth available is limited by speed of the modem and/or the available line quality from the location and, second, hotels typically have an in-house PBX (private branch exchange) which is engineered to support voice calls. The voice traffic consists of calls which typically have relatively short durations while Internet traffic typically consists of calls of longer durations. Thus, Internet use holds PBX ports and outside trunks for much longer periods of time than voice calls. To provide good access, hotels/motels must provide additional trunk groups connecting inside lines to the local exchange carrier (LEC) or interexchange carrier (IXC).

An alternative, for example, is to use either a dial-up connection, which does not provide high-speed access, or a dial dedicated data circuit (without voice capability) connected to the hotel's PBX system. The drawback of the latter is the typically higher cost of a high-speed data circuit such as ISDN (integrated services digital network) as compared to a standard voice circuit. It is generally not economically feasible for hotels/motels to provide dedicated communications facilities on a per-room basis.

An alternative to the use of portable computers is to provide a personal computer installed in a room. However, this can be expensive and difficult to maintain. For example, Internet kiosks located in airports have used PC's which are been “locked down” to prevent users from installing software, deleting software or otherwise modifying the system in some way. In this example, the PC has an operating system and software, that facilitate Internet access and browsing, residing on the local hard drive. While the cost of PC's has fallen in recent years, it is still expensive when the initial acquisition cost (hardware and software) is combined with the hardware and software maintenance costs over a multiple-year life cycle.

To provide a system such as the Internet kiosk in a hotel environment would require placing a PC and monitor in each room and providing either a dial-up modem connection or a dedicated facility to support a local area network connection. Since most hotels did not wire their facilities for local area networks in their initial construction, dial-up access is usually the only viable, economical solution.

Although local area networks using ordinary telephone wires have been known for at least 15 years, due to technology complexity and cost barriers economical Internet access from shareable locations has not been realized.

For example, U.S. Pat. No. 4,985,892, BASEBAND LOCAL AREA NETWORK USING ORDINARY TELEPHONE LINES, to Camarata, discloses a low cost local area network (LAN) concept, and associated techniques, which enable a generalized data communication facility to be established over ordinary telephone wiring. The same wires can be used simultaneously for both voice and data communications. However, this invention makes no provision for Internet access.

Also for example, U.S. Pat. No. 5,953,504, PUBLIC ACCESSIBLE TERMINAL CAPABLE OF OPENING AN ACCOUNT FOR ALLOWING ACCESS TO THE INTERNET AND E-MAIL BY GENERATING ID CODE AND SECURITY CODE FOR USERS, to Sokal, et al., discloses a computer network for allowing individual users to access the Internet. the network comprises a central unit and a plurality of individual terminals located at separate spaced locations, at least some of which are accessible to the public. Each publicly accessible unit includes a touch screen monitor/keyboard, central processing unit, telephone line communication through a modem and a system for payment of funds by the public for use of the system.

While the latter system provides communication with the Internet from publicly accessible individual terminals coupled to a central server, it uses elaborate and expensive terminals each containing a central processing unit (CPU), along with other interface features, for interacting with the user. In contrast, the present invention uses simple and inexpensive terminals and utilizes a high-speed data link over ordinary telephone lines to concentrate the processing power and terminal control functions in a central server.

In summary, it is an object of this invention to provide high-speed access to the Internet from relatively simple and inexpensive shareable terminals using existing wiring in public buildings.

### BRIEF SUMMARY OF THE INVENTION

The invention is an Internet access system which provides economical Internet access from multiple shareable locations using an existing telephone infrastructure. The invention comprises a system of multiple shareable terminals connected by telephone wiring to a central server which is connected to the Internet. The term “shareable terminal” as used herein means a relatively “dumb” terminal comprising a display, data buffers, telephone line interface circuitry (e.g., a DSL modem), and user-input devices such as a keyboard and a mouse. The DSL modem can be integrated with the terminal or connected to the terminal by an Ethernet or USB (universal serial bus) connection. The term “telephone wiring” as used herein means a network comprising common voice-grade telephone wiring which is preferably already existing in the building or other environment where the system is to be used. The term “central server” as used herein means a server comprising a computer having data processing and storage capability for supporting the shareable terminals via the telephone wiring. The central server is connected to the telephone wiring through a digital subscriber line access multiplexer (DSLAM).

The invention also includes methods of providing Internet access by providing and connecting the shareable terminals to existing (or provided) telephone wiring, providing and connecting a DSLAM to the telephone wiring, connecting the DSLAM to an existing (or provided) central server, and providing (or utilizing if it exists) an Internet access connection to the server.

### BRIEF DESCRIPTION OF THE DRAWINGS

FIG. 1 is a schematic diagram of an exemplary system of this invention.

FIG. 2 is a diagram indicating potential sites for placement of shareable terminals.

FIG. 3 is a schematic diagram of an exemplary shareable location.

FIG. 4 is a schematic diagram of the contents of an exemplary building wiring closet.

### DETAILED DESCRIPTION OF THE INVENTION

In the drawings, like reference numerals indicate like features; and, a reference numeral appearing in more than one figure refers to the same element. The drawings and the following detailed descriptions show specific embodiments of the invention. Numerous specific details including materials, dimensions, and products are provided to illustrate the invention and to provide a more thorough understanding of the invention. However, it will be obvious to one skilled in the art that the present invention may be practiced without these specific details.

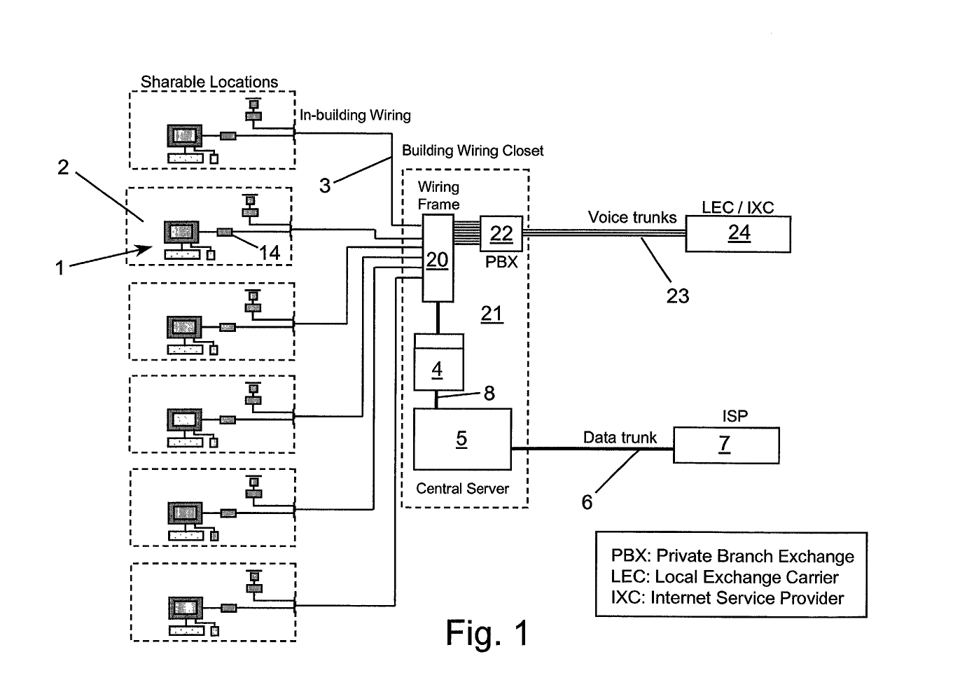

The invention comprises five major elements as illustrated in FIG. 1. The first element is a shareable terminal 1, in a shareable location 2, which provides access to telephone wiring via a DSL modem 14. The second element is telephone wiring 3 which preferably comprises the telephone wiring existing within a building. The third element is an interface DSLAM (digital subscriber line access multiplexer) 4, preferably placed in an existing secure wiring closet 21 which contains the existing wiring distribution frame 20 and an existing PBX 22. The fourth element is a central server 5. The fifth element is the Internet connection comprising the data trunk line 6 to the ISP 7.

The DSL modem converts the Internet protocol (IP) to DSL protocol and thereby communicates via telephone wiring 3 with DSLAM 4. The function of wire distribution frame 20 is to provide connections from the telephone wiring 3 to DSLAM 4 and to the building's private branch exchange (PBX) 22. The PBX is connected to an LEC/IXC central office 24 via voice-grade trunk lines 23. DSLAM 4 provides protocol conversion from DSL protocols back to IP and provides data concentration functions. DSLAM 4 is connected to central server 5 via a high-speed Ethernet connection 8. Central server 5 processes commands entered at shareable terminal 1 and forwards inquiries via data trunk line 6 to ISP 7.

The system shifts all of the local computing capabilities that would exist on a portable PC or a provided desktop PC (e.g. operating systems, application software, Internet browser) to a central server. The equipment provided in the shareable location need only consist of the shareable terminal comprising a DSL modem (either internal or external), a display device, user-input devices such as a keyboard and mouse, associated buffers and supporting hardware thereby eliminating one source of high initial and maintenance costs. The equipment may optionally support other computing functions (e.g., word processing) as desired at the shareable location. The existing building telephone wiring is used in conjunction with access (i.e. DSL) technologies to enable a high speed connection from the terminal device to a central server. When existing telephone wiring is used, the DSL technology can provide support for both voice and data over the same physical wire. The central server provides all the necessary hardware and software to provide Internet-access capability to the shareable terminal via the telephone wiring. The central server then connects via a high speed data circuit to a local ISP.

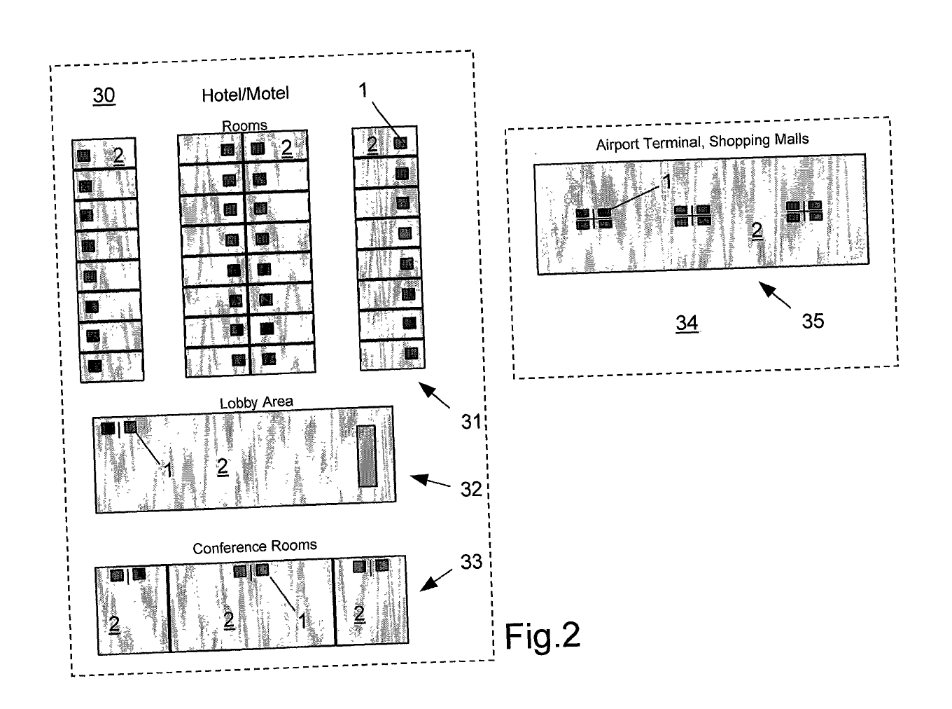

As illustrated in FIG. 2, shareable terminals 1 can be provided in a variety of shareable locations 2. They can be provided in a hotel (or motel) 30 having rooms 31, lobbies 32 and conference rooms 33. Such a system can include one or more shareable terminals in one or more rooms as well as terminals in lobby locations and conference rooms. Shareable terminals can be also be provided in large areas 35 such as airport terminal buildings, airline membership clubs or malls 34.

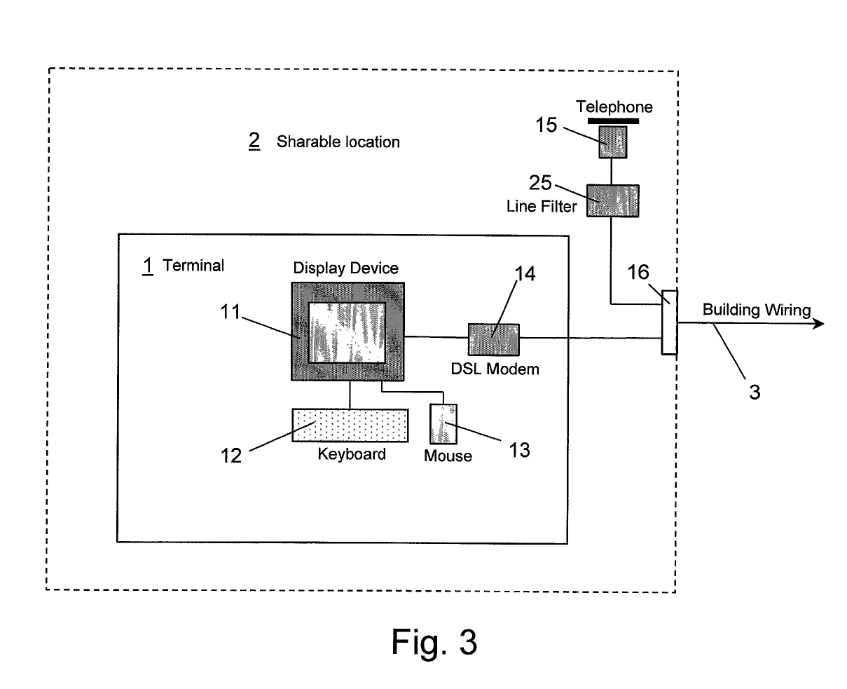

The equipment provided in a shareable location is illustrated in FIG. 3. It comprises a shareable terminal 1 further comprising a display device 11, user-input devices such as a keyboard 12 and a mouse 13, and a DSL modem 14, along with data buffers and supporting hardware (not shown). The shareable terminal does not have an operating system or any resident application software such as a dial connection manager or an Internet browser. The shareable terminal receives video and sound frames from the telephone wiring 3 via the DSL modem 14. Any user-generated input is transmitted via the telephone wiring to the central server. The central server receives the user generated input and performs the appropriate action and sends the response back to the shareable terminal. For example, the clicking on a hypertext link and the subsequent display of the new web page. The shareable terminal supports an Ethernet connection and the IP protocol.

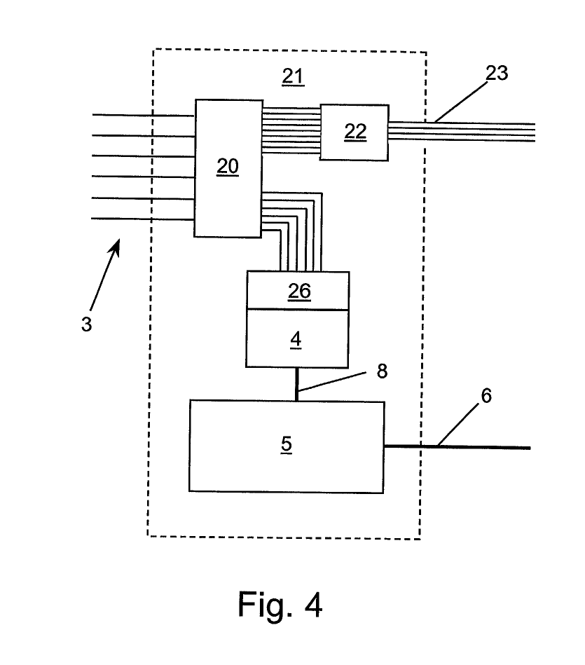

The DSL modem 14 connects the shareable terminal 1 to the telephone wiring 3 (preferably through a telephone jack 16). Although DSL modem 14 is shown here as contained within terminal 1, it can alternately be a separate device connected to terminal 1 via a network interface using internet protocol (IP) or a universal serial bus (USB). When using a DSL modem, a telephone line 3 can still function as a voice line (e.g., from a telephone 15) and a data line simultaneously. When a telephone line 3 is used for both voice and data simultaneously, a line filter 25 can be provided between the telephone and the telephone line if necessary. The telephone line for each location is connected via a wire distribution frame 20 to a receiving DSLAM 4 preferably located in a secure building wiring closet 21 as shown in FIG. 4. From the DSLAM, the connection is split to route any voice traffic back to the wire distribution frame and/or PBX 22 and route any data traffic to the central server. This portion of the system separates voice and data traffic, thus the traffic load on trunk groups to LEC's and IXC's can revert to prior engineering standards.

To support the shareable terminal, sufficient telephone wiring bandwidth must be available. Terminal devices exist today on standard Ethernet networks which typically have 10 to 100 megabits per second of bandwidth and as such can support multiple shareable terminals on the same physical network. In the invention, each shareable terminal will require a minimal amount [preferably about 1.5 megabits/second] of bandwidth. To use existing building telephone wiring, providing such bandwidth will require a DSL modem. An DSL modem provides compression and typically requires a distance of less than 9000 feet from the shareable terminal to the DSLAM. The telephone line only supports one shareable terminal and therefore is private.

As shown in FIG. 4, central server 5 is connected to telephone wiring 3 in wire distribution frame 20 through DSLAM 4. When telephone wiring 3 is used for both voice and data simultaneously, a line filter 26 can be provided between the DSLAM and the wiring if necessary. Central server 5 is connected to a local ISP 7 via a standard dedicated high speed data circuit 6.

The central server, can provide a plurality of functions, some of which are listed below. The central server preferably provides:

access to the telephone wiring via the DSLAM;

video and sound frames to the shareable terminal;

an operating system;

applications, such as an Internet browser;

access to an Internet connection; and

other optional services such as:

credit card authorization;

usage information to support an adjunct billing process (e.g., a property management system—PMS);

support for advertising (e.g. via banners within the browser);

support for local information (e.g. hotel bill information, room service);

support for streaming video;

support for printing; and

remote access to services such as usage collection, diagnostics and maintenance.

In some cases, a building may have an existing central server (i.e., computer) with sufficient processing power to support the shareable terminals. Likewise, a building may have an existing high-speed Internet connection. In such cases, the system of the invention can be installed using the existing central server or the existing Internet connection, or both, if these elements have sufficient capacity to adequately support the system.

In summary the invention significantly reduces the cost of providing a high speed Internet access capability in shareable locations. In a hotel room, for example, the shareable terminal can consist of a buffer, a DSL modem, a flat panel LCD screen with a keyboard and mouse, and supporting hardware. The network connection is made by connecting the shareable terminal through the DSL modem to the in-room telephone line. The shareable terminal has no moving parts (other than the keyboard and mouse) and no resident operating system or application software. Thus the initial cost of the terminal and the subsequent cost of maintenance and support is significantly less than a personal computer or a smart terminal.

Since the shareable terminal is connected via DSL modem to an existing telephone line, the issue of high speed access is solved without incurring additional expense of new building wiring. A secondary issue of port and trunk utilization on the PBX is also improved because of separating the voice and data traffic at the DSLAM.

The central server provides the display support and Internet access support to all connected shareable terminals. The central server aggregates all the Internet Traffic onto a single dedicated data circuit connecting to a local ISP. In addition, the central server can provide additional services such as advertising.

Multiple central servers and DSLAMs can be used in large systems or for redundancy. Routers can be provided to direct traffic to and from the servers as necessary.

The shareable terminals, DSLAM and central server along with other associated or optional equipment and software can be provided as a kit for attaching to an existing telephone system.

While the invention has been described above with respect to specific embodiments, it will be understood by those of ordinary skill in the art that various changes in form and details may be made therein without departing from the spirit and scope of the invention.

All references mentioned herein are hereby incorporated by reference to the extent that they are not inconsistent with the present disclosure.

What is claimed is:

1. An Internet access system comprising:
one or more shareable terminals;
a DSLAM;
telephone wiring, coupled to said shareable terminal and to said DSLAM;
a central server, coupled to said DSLAM; and
an Internet connection, comprising a trunk line coupled to said central server and to an Internet service provider.

2. A system as in claim 1 wherein said shareable terminal comprises:
a display device;
one or more user-input devices;
a data buffer;
a DSL modem; and
supporting circuitry interconnecting said display device, said user-input device, said data buffer and said DSL modem.

3. A system as in claim 1 further comprising a DSL modem coupled to said shareable terminal and to said telephone wiring.

4. A system as in claim 1 wherein one or more telephones are coupled to said telephone wiring.

5. A system as in claim 4 comprising a line filter between said telephone and said telephone wiring.

6. A system as in claim 1 wherein a PBX is coupled to said telephone wiring.

7. A system as in claim 1 further comprising a line filter between said telephone wiring and said DSLAM.

8. A system as in claim 1 wherein said central server comprises:
a storage device;
an operating system; and
one or more application programs.

9. A system as in claim 1 wherein said central server and said DSLAM are contained within a secure enclosure.

10. A system as in claim 1 wherein said telephone wiring comprises telephone wiring existing prior to installation of said system.

11. A system as in claim 1 wherein said central server comprises a server installation existing prior to installation of said system.

12. A system as in claim 1 wherein said Internet connection comprises an Internet connection existing prior to installation of said system.

13. A method for providing Internet access comprising the steps of:
providing one or more shareable terminals;
providing telephone wiring;
connecting the terminals to the wiring;
providing a DSLAM;
connecting the wiring to the DSLAM;
providing a central server;
connecting the DSLAM to the server;
providing an Internet connection; and
connecting the server to the Internet connection.

14. A method for adding Internet access to existing telephone wiring comprising the steps of:
providing one or more shareable terminals;
providing one or more DSL modems;
coupling the terminal to the DSL modem;
coupling the DSL modem to the existing wiring;
providing a DSLAM;
coupling the existing wiring to the DSLAM;
coupling the DSLAM to a central server; and
coupling the server to an Internet connection.

15. A method as in claim 11 further comprising the steps of:
providing said central server; and
providing said Internet connection.
